(19) United States
(12) Patent Application Publication
(10) Pub. No.: US 2025/0118850 A1
(43) Pub. Date: Apr. 10, 2025

(54) Battery- Receiving Device And Method For Producing Battery- Receiving Device

(71) Applicant: Dornier Litetech GMBH, München (DE)

(72) Inventor: Christian Platzer, Mettersdorf a.S. (AT)

(21) Appl. No.: 18/724,391

(22) PCT Filed: Dec. 8, 2021
(86) PCT No.: PCT/EP2021/084833

§ 371 Date: Jun. 26, 2024

(51) Int. Cl. H01M 50/249; H01M 50/224; H01M 50/227; H01M 50/229

(52) U.S. Cl. CPC H01M 50/249; H01M 50/224; H01M 50/227; H01M 50/229; H01M 2220/20

(57) ABSTRACT

The invention relates to a method for manufacturing a battery holding device (100) for one or more batteries or battery cells of an electric motor for a vehicle, comprising the following steps: a) providing a base unit (10) made from a first material (A); b) forming a plurality of anchoring structures (12) on the upper side (11) and/or another side of the base unit (10); c) applying a frame unit (13) made of a second material (B) to the base unit (10), wherein the second material (B) is at least partially or completely liquefied or melted by the supply of heat for application to the base unit (10), such that a portion of the liquefied melted second material (B) fills and/or surrounds the anchoring structures (12); (d) cooling the base unit (10) and the frame unit (13), wherein the second material (B) solidifies in and/or around the anchoring structures (12) to form an anchorage (14).

The invention relates to a method of manufacturing a battery holding device according to claim 1 and a battery holding device according to claim 17.

At present, electromobility is becoming increasingly important as part of the desired transport transition. Land vehicles such as cars or special vehicles, but also aircraft such as airplanes, drones or helicopters or watercraft with electronic drives are becoming increasingly popular and should replace fuel-based drives as completely as possible in the near future. The problem with the energy density of the batteries or rechargeable batteries used is well known, which is associated with a comparatively short range (compared to fuel-based drives). Another disadvantage is the comparatively high weight of the batteries for the electric motors. As there are no promising approaches to drastically reduce the weight of the cell-chemical components of the batteries, at least to date, various approaches are being pursued to reduce the weight of battery holders or battery housings. Usually, a type of tray is used to hold battery packs (pack to cell) or cells directly (cell to pack). This type of tray must keep the cells at the right temperature and protect them mechanically. At the same time, the tray should of course be lightweight so as not to consume unnecessary energy during use. The problem with manufacturing such trays has been that trays that cool and protect the cells comparatively well (in the event of an accident, for example) are often not particularly light or cannot be designed flat enough to allow the cells to lie flat in the tray. However, a flat support is particularly advantageous for effective temperature control (cooling/heating) of the batteries. This also prevents tension in the batteries. Accordingly, various post-processing steps are necessary in conventional methods in order to obtain a flat contact surface in a corresponding battery holder. So far, approaches have also been pursued to manufacture such trays entirely by means of die casting, although this requires systems with extremely high clamping forces of around 5,000 tons in order to meet the requirements of the complex geometries of a battery holder. However, such systems with correspondingly high clamping forces are only available in extremely small quantities worldwide, as these systems fill entire halls and are extremely expensive.

In the light of the above, the object of the present invention is therefore to provide a manufacturing method for a battery holding device which is inexpensive and requires only minimal technical effort and drastically reduces the need for reworking. A further object of the invention is to provide a battery holding device which overcomes the above-mentioned disadvantages.

The object is solved by a method for manufacturing a battery holding device having the features of claim 1 and a battery holding device having the features of claim 17.

Advantageous further developments result from the sub-claims.

In particular, the invention is solved by a method for manufacturing a battery holding device for one or more batteries or battery cells of an electric motor for a vehicle, wherein the method comprises the following steps of:
a) providing a base unit from a first material;
b) forming a plurality of anchoring structures on the upper side and/or another side of the base unit;
c) applying a frame unit made of a second material to the base unit, wherein the second material is at least partially or completely liquefied or melted by the supply of heat for application to the base unit, such that a portion of the liquefied or melted second material fills and/or surrounds the anchoring structures, in particular in a form-fitting manner;
d) cooling the base unit and the frame unit, wherein the second material solidifies in and/or around the anchoring structures to form an anchorage.

An important idea of the invention is to provide a way of manufacturing comparatively light but very robust battery holding devices as simply and inexpensively as possible. Preferably, the battery holding device is to be manufactured at least in part using an injection molding process and/or die casting process. However, the decisive factor here is that the proposed approach provides for a base or the base unit of the battery holding device to be provided as a separate element and a frame (which together with the base unit essentially forms the battery holding device) to be injection-molded or cast onto this base unit or at least partially fused to it. If necessary, the base unit can also be at least partially (or completely) extrusion-coated or encapsulated. For this purpose, the anchoring structures can be introduced on one or more additional sides (left side, right side, underside), for example. The fact that the base is provided separately means that the clamping force required by the corresponding injection molding systems to mold or inject the frame is comparatively low, so that even smaller systems are able to apply this clamping force. Ideally, the base or the base unit is already provided in such a way that few or no post-processing steps are required in terms of the flatness of the base (for supporting the batteries, accumulators or battery cells).

A vehicle for which (in which) the battery holding device according to the invention can be used is understood here to mean any type of vehicle, in particular land, air and water vehicles (with electric drive). In particular, this means, for example, electric automobiles.

In one embodiment, the base unit is designed as an, in particular integral, extruded profile element, which preferably has a plurality of (separate) fluid channels.

Extruded profile elements, e.g. made of aluminum, are inexpensive and quick to manufacture. Due to their manufacturing process (extrusion), the profiles inherently offer a very even (flat) surface or upper side, which provides an even support for batteries or accumulators in the battery holding device without the need for post-processing. Different heights or wall thicknesses can be realized easily and flexibly, as can different lengths or widths of the extruded profile element. Overall, it is therefore very easy to achieve a particularly flat base with additional or simultaneous flexibility in terms of dimensions.

In one embodiment, step b) for forming a plurality of anchoring structures comprises at least one of a laser machining process, an erosion process, a machining process and a rolling process.

The aforementioned surface finishing processes allow the anchoring structures to be arranged and formed as precisely as possible. The precision ensures that the top surface of the base unit is only machined at points where part of the frame is to be applied (precisely distributed on or in the projection surface of the frame unit and not outside). In this respect, the evenness of the floor or the top of the base unit inside the battery holder is improved or guaranteed.

In one embodiment, the anchoring structures are formed such that they each have a maximum width of between 0.05 and 0.8 mm, preferably between 0.2 mm and 0.4 mm on the (upper) side of the base unit and/or each have a maximum depth and/or height of between 0.1 mm and 1 mm, preferably between 0.2 mm and 0.4 mm into the surface of the base unit. In alternative embodiments, in which the anchoring structures are introduced, for example, by milling or rolling, a maximum width of the anchoring structures may also be approximately 1 mm.

In this way, the anchoring structures are formed (at least in sections or areas) as anchoring recesses and/or (at least in sections or areas) as anchoring protrusions.

The comparatively small dimensions of the anchoring structures make it possible to arrange a large number of these structures (recesses and/or protrusions)—for example several (more than 10, preferably more than 20) per square centimeter. This creates a strong connection between the frame unit and the base unit.

In one embodiment, the anchoring structures are formed with an undercut, in particular such that a respective anchoring structure has at least one area which is formed wider than an area (for example an opening) of the respective anchoring structure on the upper side of the base unit and/or such that a plurality of anchoring structures (for example in pairs) are formed to extend at an opposite angle.

This is a simple way of creating a seamless and inseparable (monolithic) connection between the base unit and frame unit with high connection rigidity. This makes the connection between the frame unit and the base unit particularly stable against deformation (e.g. due to a rear-end collision) or against vibrations (e.g. during normal driving), so that batteries arranged inside the battery holding device are well protected and stored. In addition, a seamless and gap-free joint is made possible so that the battery holder is fluid-tight. This (also) enables and/or supports effective and efficient cooling (or heating) of the battery holder.

According to one embodiment, the plurality of anchoring structures are arranged in step b) in an area that corresponds to a projection surface of the frame unit to be applied in step c). Particularly preferably, the anchoring structures are arranged exclusively in the area of the projection surface of the frame unit.

Due to the special arrangement of the anchoring structures, the flatness of the unmachined base (area of the upper side in which no anchoring structures are/were formed) is maintained, so that no post-processing steps such as milling, CNC machining or similar are required to machine the inside of the battery holder and to obtain the flattest possible contact surface for the batteries. In this respect, efficient cooling or temperature control is supported.

In one embodiment, step c) comprises casting and/or injection molding the second material for applying the frame unit onto and/or around the base unit. An injection molding process or die casting process is particularly preferred here.

This allows cost-effective production in large quantities. At the same time, the geometry of the frame unit can be selected more or less freely. The necessary closing force of a mold is the product of the projection surface of the component to be produced including the casting system (component including sprue, overflows and venting channels) and the casting pressure. By inserting a (finished) base unit into the mold, only the frame unit (with a comparatively small projection surface) is injected according to the method described here. This drastically reduces the required clamping force, as the force only has to be applied for the injection molding of the frame unit. Preference is therefore given to geometries of a frame unit that have a projection surface that corresponds to a maximum of 10%, preferably a maximum of 5%, of the upper side of the base unit. Therefore, according to the method described herein, only a comparatively low closing force of the mold of the injection molding machine is required, e.g. according to the method described herein only between 850 t and 1000 t. Conventional methods, in which a battery holder is completely injection molded (for example with base and frame), require up to 5000 t. The present invention therefore allows production with considerably smaller and less expensive systems.

According to one embodiment, step c) comprises forming at least one or more functional elements of the frame unit.

By molding (additional) functional elements (such as reinforcing ribs or screw-on elements) directly integrated into the casting process, the manufacturing process is further simplified as the elements do not have to be assembled or manufactured in subsequent steps. Direct integral molding also enables seamless and gap-free processing, which supports effective and efficient cooling of the battery holding device.

According to a preferred embodiment, these functional elements comprise at least one of one or more screw-on elements (for example for mounting a cover), one or more intermediate webs, one or more (stiffening) ribs and one or more cable and/or conductor track guides.

This also reduces the corresponding post-processing steps and therefore the work involved. This allows simple, cost-effective and, in particular, fast production of the battery holding device.

In one embodiment, the first material essentially comprises aluminum and/or the second material essentially comprises a magnesium alloy, preferably a refractory magnesium alloy, and/or plastic, or aluminum alloys.

The use of aluminum in the base unit enables good heat conduction. The cooling capacity or, optionally, heating capacity can therefore be supported (with a comparatively low component weight). In addition, aluminum has high strength and high thermal resistance or conductivity. Magnesium, magnesium alloys or plastic are preferred for the frame unit. Overall, due to their low density, these materials help to reduce the overall weight of the battery holding device.

According to an (alternative) embodiment, step c) comprises providing the frame unit at least partially as a prefabricated component, in particular as a 3D-printed prefabricated component or an injection-molded prefabricated component. Preferably, the prefabricated component is placed directly on the base unit.

In one embodiment, the prefabricated component of the frame unit can have flame retardants, in particular be coated with flame retardants. This increases the ignition temperature of the frame unit and thus further improves safety.

The prefabrication of a frame unit can be cost-effective for small series. A corresponding frame unit (or parts thereof) that are produced using 3D printing can also be made as complex as required.

According to one embodiment, step c) comprises liquefying or melting the second material of the prefabricated component partially or locally, in particular on a side that is in contact with or can be brought into contact with the base unit, by applying heat.

This allows a simple, quick and seamless connection between the frame unit and the base unit.

In one embodiment, step c) comprises melting the frame unit locally by heating the base unit.

Melting the frame part directly by means of the heated base unit ensures close proximity between the base unit and the frame unit. In this way, it is advantageously avoided that parts of the melted frame unit cool down before they come into contact with the base unit. In this respect, the method is thus efficiently accelerated.

According to one embodiment, step c) comprises pressing molten parts of the frame unit with the base unit so that the (locally) molten parts of the frame unit positively fill or surround the anchoring structures of the base unit. Under certain circumstances, the finished part of the frame unit can be completely or partially (additionally) encapsulated or extrusion-coated in one step (of step c)). Alternatively, no further processing (such as encapsulating, extrusion-coating) of the prefabricated component can (must) take place.

This is a simple way of creating a seamless and inseparable (monolithic) connection between the base unit and the frame unit. This makes the connection between the frame unit and the base unit particularly stable against deformation (e.g. due to a rear-end collision) or against vibrations (e.g. during normal driving), so that batteries arranged inside the battery holding device are well protected and stored. In addition, a seamless and gap-free joint is made possible. This allows effective and efficient cooling of the battery holder.

In one embodiment, the first material essentially comprises aluminum and/or the second material (B) essentially comprises plastic, preferably fiber-reinforced plastic and/or carbon-reinforced plastic.

The use of aluminum in the base unit enables good heat conduction. The cooling capacity can therefore be optimized (with a comparatively low weight of the component). In addition, aluminum has high strength and high thermal resistance and conductivity. In the case of a prefabricated component, plastic is the preferred material for the frame unit. Plastic is comparatively light, so that a low overall weight of the battery holder is possible. Fiber reinforcements in the plastic can easily increase stability. Carbon reinforcements in the plastic make it possible to prevent surrounding devices from being disturbed by unwanted electrical or electromagnetic effects. At the same time, the inside of the battery holding device is also better shielded from the surroundings in this way. A “carbon reinforcement” can, for example, consist of carbon fibers inserted into the plastic matrix.

According to a preferred embodiment, steps a) to d) are carried out in a press or a mold of an injection molding machine. Alternatively, only step b) can be carried out in advance.

It is advantageous to carry out all method steps directly in the mold. This means that the method can be carried out comparatively quickly. For example, the anchoring structures can be formed directly in the mold using a processing laser. On the other hand, it is also possible to carry out the surface treatment of the base unit in advance. This can be advantageous, for example, if the same type of base unit is used for different types (e.g. different geometries) of frame units.

In one embodiment, the method comprises a step of attaching and/or pressing fluid guiding devices onto and/or into the fluid channels of the base unit. Preferably, anchoring structures can (also) be formed on and/or in the fluid guiding devices (in step b)). Further preferably (in step c)), the fluid devices can be extrusion-coated or encapsulated with the second material (so that the fluid guiding devices are firmly connected to the (monolithic) battery holding device). This allows further post-processing steps to be reduced. In particular, the fluid guiding devices are designed to connect the fluid channels of the base unit to each other (in series) so that the path that the fluid travels in the base unit during flushing is increased. In this way, temperature control can be improved. Alternatively or additionally, the fluid guiding devices can have connections for inlet and/or outlet.

The object of the invention is furthermore solved in particular by a (monolithic) battery holding device for a vehicle, in particular manufactured by a method as described above, wherein the battery holding device has the following:
a base unit made of a first material, which has an arrangement of a plurality of anchoring structures on an upper side and/or a further side;
a frame unit made of a second material, which is arranged in sections as a circumferential, in particular completely circumferential, frame on the upper side of the base unit,
wherein the frame unit has a plurality of anchoring structures, each of which positively fills and/or surrounds a corresponding anchoring structure of the plurality of anchoring structures of the base unit.

The battery holding device according to the invention can be used to achieve the same advantages as those already described in connection with the manufacturing method according to the invention. It should also be noted that the features described in the context of the method according to the invention also apply to the battery holding device according to the invention. Features of the method according to the invention can be transferred to the battery holding device according to the invention, in that the battery holding device is designed in accordance with the features of the method.

In one embodiment, the base unit is designed as an, in particular integral, extruded profile element, which preferably has a plurality of fluid channels for flushing through or fluid cooling of the base unit.

In one embodiment, the frame unit 13 has a projection surface which occupies at most 10%, preferably at most of 5%, of the upper side of the base unit.

In this way, the required clamping forces of an injection molding system can be kept low, as only a low sprue pressure needs to be applied. This means that such a battery holding device can also be produced cost-effectively with smaller (and widely used) systems. In this way, for example, only a clamping force of between 850 t and 1000 t is required.

In one embodiment, the anchoring structures have a maximum width of between 0.05 and 0.8 mm, preferably between 0.2 mm and 0.4 mm on the (upper) side of the base unit and/or a maximum depth or height of between 0.1 mm and 1 mm, preferably between 0.2 mm and 0.4 mm.

In one embodiment, the first material essentially comprises aluminum and/or the second material essentially comprises a magnesium alloy, in particular a refractory magnesium alloy, or an aluminum alloy and/or the second material comprises plastic, preferably fiber-reinforced plastic and/or carbon-reinforced plastic.

In the following, the invention is also described with regard to further details, features and advantages, which are explained in more detail with reference to the figures. The features and combinations of features described, as shown below in the figures of the drawing and described with reference to the drawing, are applicable not only in the combination indicated in each case, but also in other combinations or in an isolated position, without departing from the scope of the invention, wherein:

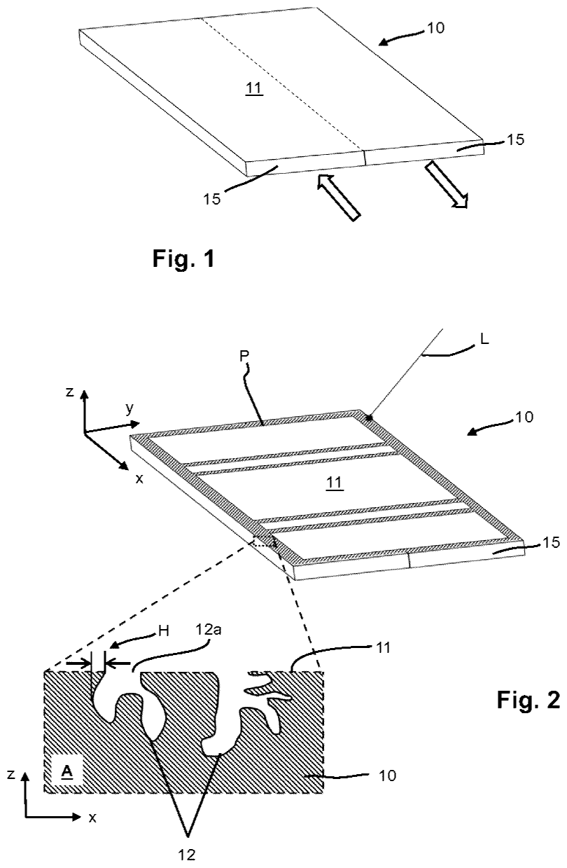

FIG. 1 shows a perspective view of a base unit according to an exemplary embodiment;

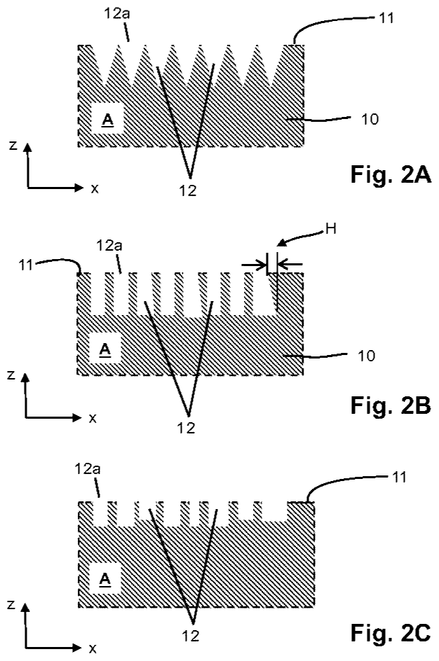

FIG. 2 shows a schematic view of an exemplary embodiment for the insertion of anchoring structures in a projection surface P on the upper side of a base unit by means of a processing laser;

FIGS. 2A-2C show different examples of anchoring structures that have been inserted into the base unit using different methods;

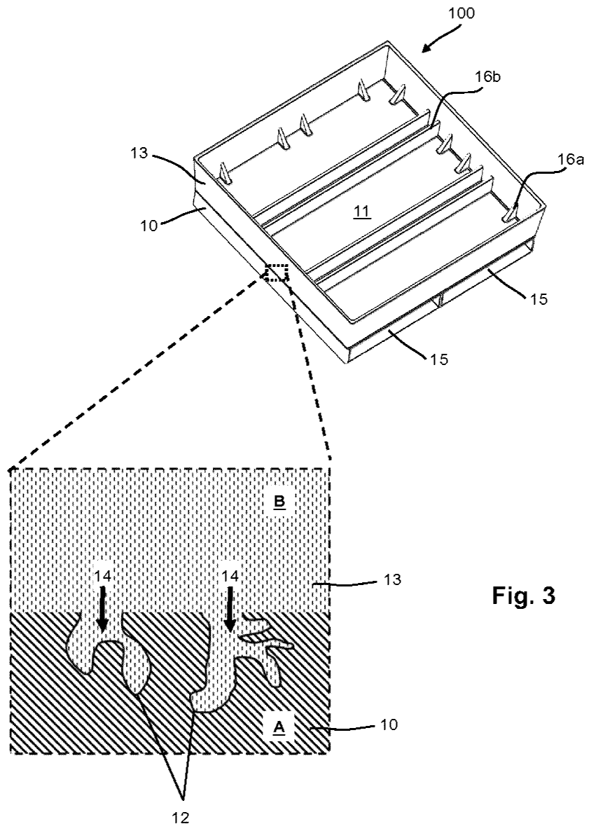

FIG. 3 shows a perspective view of a battery holding device according to the invention according to an exemplary embodiment, as well as a sketched detailed view of the positive connection of the frame unit and base unit according to the exemplary embodiment;

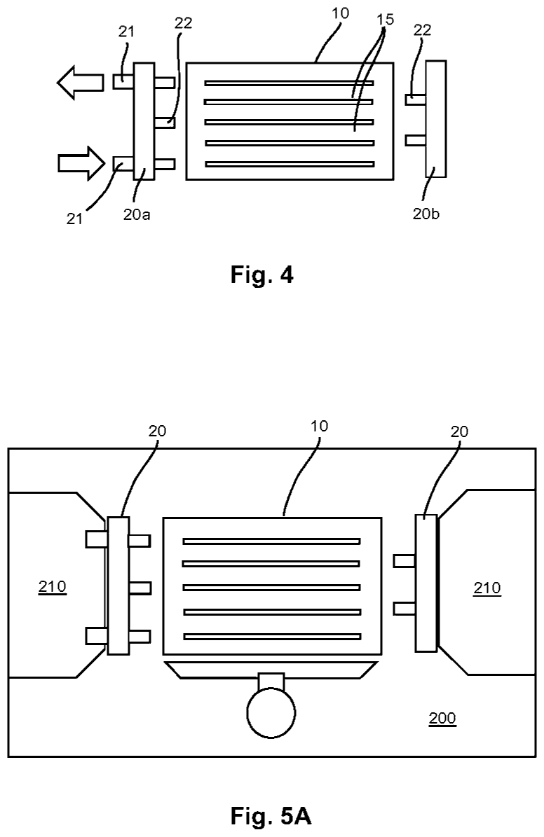

FIG. 4 shows an exemplary embodiment of a base unit with (attachable) fluid guiding devices for flushing the base unit with a (cooling) fluid;

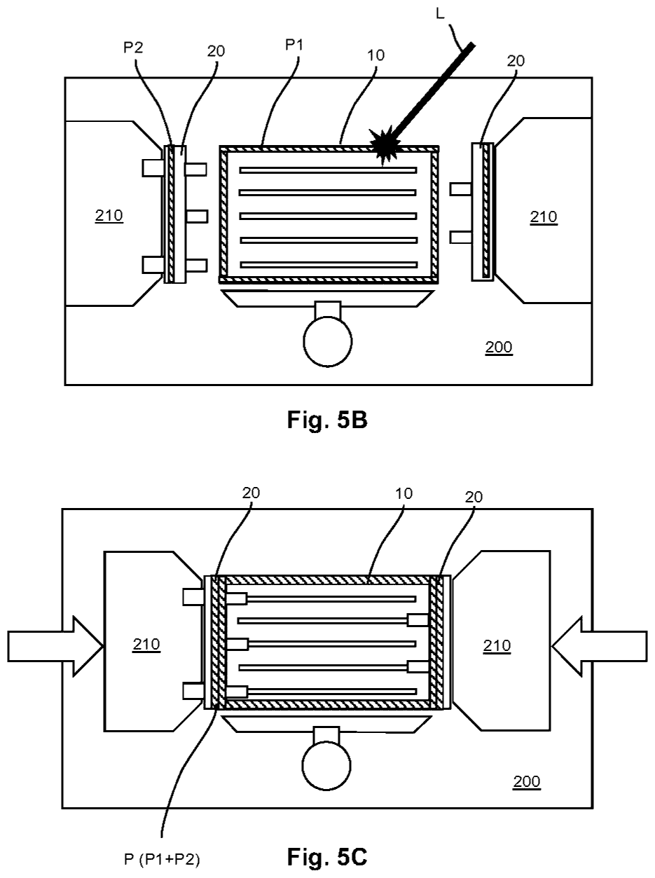

FIGS. 5A-5 show the schematic sequence of a manufacturing method of a battery holding device with a tool according to an exemplary embodiment;

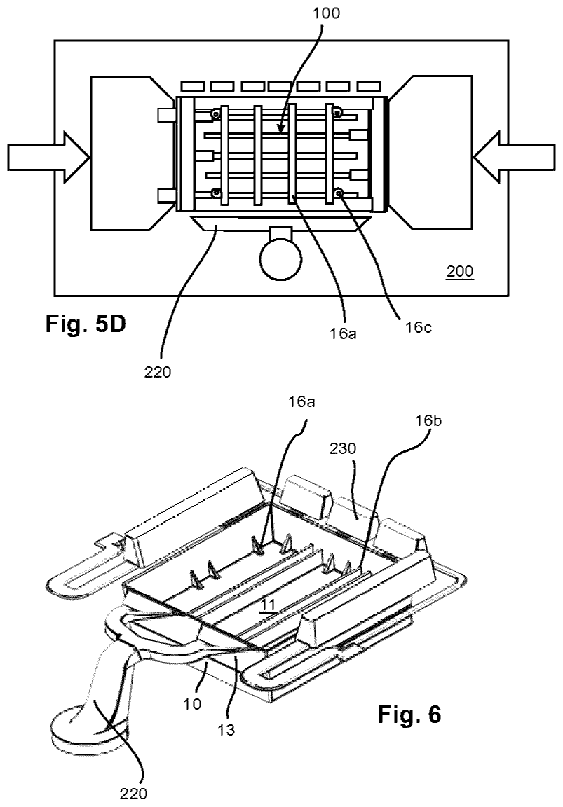

FIG. 6 shows a schematic interior view of a mold (mold cavity) for injection molding a frame unit onto a base unit according to an exemplary embodiment.

The figures are merely schematic in nature and are provided solely for the purpose of understanding the invention. Similar elements are provided with the same reference signs in the description of the exemplary embodiments.

FIG. 1 shows a perspective view of a base unit 10 according to an exemplary embodiment. The base unit 10 is designed as an integral element which has two cavities 15 which extend along a longitudinal direction of the base unit 10 and each have open ends. The cavities 15 are designed as fluid channels 15 for flushing the base unit 10 with a (cooling) fluid, as shown by the arrows in FIG. 1. In an exemplary embodiment of a base unit 10 of a tray for electric vehicles, the number of fluid channels can be between 6 and 20, for example, depending on the size of the tub. In general, the number and shape of the channels is based on thermodynamic calculations and can be freely selected.

The base unit 10 is made from a first material A. According to an exemplary embodiment, the base unit is manufactured as an extruded aluminum profile element by extrusion.

The height of the fluid channels 15 is between 1 and 15 mm, for example. Alternatively or additionally, the wall thickness of the extruded profile element 10 is approximately 2 mm.

It is particularly preferred that the extruded profile element has a flatness, especially on the upper side 11, of at most +/−0.8 mm, preferably +/−0.2 mm.

In the exemplary embodiment shown in FIG. 1, the base unit has a length of approximately 900 mm and a width of approximately 760 mm. However, alternative dimensions are easily possible.

In alternative exemplary embodiments (not shown), the base unit 10 can also comprise a base plate (for example made of aluminum), which forms an upper side of the base unit 10. Fluid guiding structures for flushing with a cooling fluid can be arranged on an underside of the base plate—e.g. by means of a plastic and/or carbon element arranged on the base plate that can be flushed.

FIG. 2 shows an example for the introduction of anchoring structures 12 into the base unit.

According to the exemplary embodiment, the upper side 11 of the base unit 10 is processed with a processing laser. For this purpose, at least one laser beam L of the processing laser is moved along a trajectory. The trajectory of the laser beam L is selected in such a way that only the areas of the surface 11 in an area P (hatched parts of the surface 11) are processed.

The surface P corresponds to the projection surface (or the floor plan) of the frame unit 13 (not shown), which is to be applied to the upper side 11 in a subsequent step. The upper side 11 of the base unit 10 extends in the x-y direction and a height of the base unit 10 extends in the z direction. The projection surface P of the frame unit is the ground plan of the frame unit to be applied, including intermediate webs, stiffening ribs, etc.

The properties of the laser beam L (power, optionally pulse duration, beam direction or trajectory in x-y-z direction, focus size, etc.) can be controlled in such a way that anchoring structures 12 are introduced into/onto the upper side 11 of the base unit within the projection surface P.

Exemplary anchoring structures, which are formed as anchoring recesses 12, are shown in sketch form in the detailed view of FIG. 2. The detailed view shows a cross-section through an upper area of the base unit 10. The anchoring recesses 12 extend from the upper side 11 preferably essentially vertically (in the z-direction) into the depth of the base unit 10. The depth of the anchoring recesses 12 is less than a wall thickness of the base unit 11, so that no connection to the fluid channels 15 is established.

In corresponding exemplary embodiments, the anchoring structures 12 may be similar or identical or may be formed completely differently, as shown in the detailed view shown. In particular, the anchoring structures can be formed as pure anchoring recesses 12 (as shown). Alternatively or additionally, it is possible to form anchoring protrusions 12.

Particularly preferably, the anchoring structures 12 each have an undercut H, as shown in the detailed view of FIG. 2. Within the respective anchoring recess 12, there is at least one area that is wider than an opening 12a of the respective anchoring recess 12 on the upper side 11 of the base unit 10. The formation of the undercut H can, under certain circumstances, also be formed by microscopically small local material irregularities.

FIG. 2A shows an example of several anchoring structures 12 (as described in FIG. 2), which are introduced into the base unit by means of rolling/milling. In particular, individual anchoring structures 12 may have different (opening) angles, wherein acute angles, in particular of less than 30°, preferably less than 20°, are generally preferred.

FIG. 2B shows a further example of several anchoring structures 12 (as described in FIG. 2) that have been introduced by means of laser radiation. The anchoring structures 12 that are inserted by means of laser radiation are preferably inserted as trenches with walls that are as parallel as possible. This method may also allow the introduction of macroscopic undercuts H in the anchoring structures 12.

FIG. 2C shows a further example of several anchoring structures 12 (as described in FIG. 2) that have been introduced using an erosion process. In this process, almost randomly distributed structures are formed, which are preferably as jagged as possible. These could also be produced using an etching process, for example.

The methods described here for creating the anchoring structures can also be combined.

In particular, it is also conceivable that several anchoring structures 12 (for example in pairs) are each designed to extend at opposite angles.

Optionally, several surface treatment methods can also be combined.

According to the method described here, a frame unit 13 made of a second material B is applied to the base unit on the upper side 11.

An exemplary embodiment of a battery holder 100 manufactured in accordance with the invention is shown in FIG. 3.

The battery holding device 100 shown here has the base unit 10 made of the first material A and the frame unit 13 made of a second material B.

According to the exemplary embodiment, the frame unit is arranged as a completely surrounding frame on the upper side 11 of the base unit 10. In addition to the circumferential frame, the frame unit 13 can also have functional elements 16. In the exemplary embodiment shown, these are designed as stiffening ribs 16a and intermediate webs 16b.

According to a preferred exemplary embodiment, the space between the intermediate webs 16b provides a receiving area for batteries or battery cells (not shown).

Lower parts or areas of the frame unit 13 are designed as anchoring or as anchoring structures 14 according to the detailed view of FIG. 3, wherein these anchoring structures 14 are designed to correspond with the anchoring structures 12.

These anchors 14 are cast or inserted into the anchoring structures 12 so that the anchors 14 fill the anchoring structures 12 in a form-fitting manner. Or in other words, so that the anchoring structures 12 surround the anchors 14 in a form-fitting manner.

For this purpose, the second material B is at least partially (or locally) or completely liquefied or melted by applying heat. In this way, molten parts of this second material B can flow into/around the anchoring structures 12 and fill and/or surround them to connect the frame unit 13 to the base unit 10.

Cooling causes the second material B to solidify in and/or around the anchoring structures 12 and the frame unit 13 is firmly and positively connected to the base unit 10 in a fluid-tight manner.

Preferably, the first material A and the second material B are selected so that there is no alloying of the two materials. In this way, the mechanical properties of the connection between the base unit and the frame unit can be controlled. In contrast, alloying between the units could be disadvantageous, as alloying along the connection between the units could lead to locally undefined material properties.

FIG. 4 shows a further exemplary embodiment of a base unit 10. According to this exemplary embodiment, the base unit 10 is configured in such a way that fluid guiding devices 20a, 20b can be plugged on. According to the exemplary embodiment, the fluid guiding device 20a is designed with means 21 for supplying and/or discharging a fluid. The means 21 can be designed as corresponding connections (e.g. for attaching corresponding inlet or outlet hoses).

In addition, the fluid guiding devices 20a, 20b have corresponding fluid deflecting devices 22 which are designed to be inserted (plugged) into the fluid channels 15. The fluid deflecting devices 22 can thereby be brought into connection with the fluid channels in such a way that a fluid deflection from a first fluid channel 15 into a second fluid channel 15 takes place, wherein the fluid deflecting devices 22 form a fluid guide with central webs of the base unit 10. In this way, the fluid channels 15 of the base unit 10 can be flushed through in a meandering manner, for example, so that a fluid path results which is many times longer than a longitudinal extension of the base unit 10 or the battery holding device 100.

By flushing the fluid channels 15 with a corresponding (cooling) fluid, the base unit 10 or the battery holder 100 can be cooled or tempered (possibly also heated).

FIGS. 5A to 5D show a schematic diagram of a manufacturing process for a battery holding device with a mold 200. In one exemplary embodiment, the tool 200 is a clamping unit or mold of an injection molding machine.

In a first step (FIG. 5A), the attachable fluid guiding devices 20 (see FIG. 4) are placed on sliders 210 and the base unit 10 is inserted into the tool 200.

In the following (FIG. 5B), the anchoring structures 12 are formed in the upper side 11 of the base unit 10 by means of a laser L in this exemplary embodiment. The surface processing is carried out here directly in the tool 200 (mold). As described above, the anchoring structures 12 are arranged only (or exclusively) in an area P1 of the upper side 11 (and not on the entire upper side 11).

It may optionally also be possible to install the anchoring structures 12 on and/or in the fluid guiding devices 20 in an area P2.

Subsequently (FIG. 5C), the fluid guiding devices 20 are pushed (pressed) onto the base unit 10 by means of the sliders 210 in such a way that the fluid deflecting devices 22 engage in the fluid channels 15 (see also FIG. 4).

The areas P1, P2 in which the anchoring structures 12 are arranged then (jointly) form the projection surface P of the frame unit 13 to be attached in a subsequent step.

Alternatively, it is also possible that the fluid guiding devices 20 are first pushed (pressed) onto the base unit 10 and the anchoring structure 12 is (only) formed afterwards.

FIG. 5D shows an example of how the overall structure of the battery holder 100 is molded.

The second material B for forming the frame unit 13 is melted and filled (injected) through the feed 220 (e.g. nozzle) into the shaping cavity (mold) of the tool 200.

For this purpose, the second material B fills the cavity and also fills and/or surrounds the anchoring structures 12 of the base unit 10 (and optionally the fluid guiding devices 20).

In this step, further functional elements 16 such as stiffening ribs 16a and/or intermediate webs 16b and/or screw-on elements 16c can be formed. The screw-on elements 16c can, for example, be designed and arranged for mounting a cover for closing the battery holder. The functional elements 16 can be arranged both on the upper side and, under certain circumstances, on the underside of the base unit 10.

FIG. 6 shows a perspective view of an exemplary embodiment of the battery holding device 100 within the cavity of the mold 200. The illustration of FIG. 6 is essentially similar to the situation shown in FIG. 5D, with the difference that the battery holding device 100 according to the exemplary embodiment in FIG. 6 does not have any fluid guiding devices. In addition, FIG. 6 shows an exemplary embodiment of a frame unit 13 with intermediate webs 16b and reinforcing ribs 16a on the upper side 11 of the base unit 10.

FIG. 6 shows how the (melt) feed 220 of the mold 200 is arranged. Furthermore, the cavity of the mold 200 may, for example, have overflow and/or venting devices 230.

The second material B for forming the frame unit 13, which is supplied via the feed 220, is here preferably a magnesium alloy, preferably a refractory magnesium alloy, or an aluminum or plastic alloy.

Preferably, the second material B may comprise the following:
0.1 wt. % to 5.0 wt. % carbon (C), preferably 0.2 wt. % to 4.0 wt. %, more preferably 0.5 wt. % to 3.5 wt. % carbon (C);
1.0 wt. % to 10 wt. % aluminum (Al);
0.1 wt. % to 2.0 wt. % calcium (Ca);
0.05 wt. % to 2.0 wt. % yttrium (Y);
optionally more than 0.0 wt. % to 6.0 wt. % zinc (Zn);
optionally more than 0.0 wt. % to 1.0 wt. % manganese (Mn); and
a balance of magnesium (Mg) and a residue of unavoidable impurities.

This makes the frame unit 13 particularly robust and comparatively light. It also has a high ignition resistance.

For details of the mechanical connection between base unit 10 and frame unit 13 with corresponding anchorages 14 and anchoring structures 12, please refer to the comments on FIG. 2.

### LIST OF REFERENCE SYMBOLS

100 Battery holding device
10 Base unit
11 Surface/upper side of the base unit
12 Anchoring structures
12a Opening
13 Frame unit
14 Anchorage(s) (parts of the frame unit)
15 Fluid channels
16 Functional elements
20a,b (Attachable) fluid guiding device
21 Fluid inlet/outlet
22 Fluid deflecting devices
200 Mold
210 Slider of the mold
A First material (of the base unit)
B Second material (of the frame unit)
H Undercut
L Processing laser beam
P Projection area of the frame part

1. Method for manufacturing a battery holding device (100) for one or more batteries or battery cells of an electric motor for a vehicle, comprising the following steps:
a) providing a base unit (10) from a first material (A);
b) forming a plurality of anchoring structures (12) on the upper side (11) and/or another side of the base unit (10);
c) applying a frame unit (13) made of a second material (B) to the base unit (10), wherein the second material (B) is at least partially or completely liquefied or melted by the supply of heat for application to the base unit (10), such that a portion of the liquefied or melted second material (B) fills and/or surrounds the anchoring structures (12);
d) cooling the base unit (10) and the frame unit (13), wherein the second material (B) solidifies in and/or around the anchoring structures (12) to form an anchorage (14).

2. Method according to claim 1, wherein the base unit (10) is designed as
an integral, extruded profile element, which has a plurality of fluid channels (15).

3. Method according to claim 1, wherein the step b) for forming the plurality of anchoring structures (12) comprises at least one of a laser machining processing, an erosion process, a machining process and a rolling process.

4. Method according to one of claim 1, wherein the anchoring structures (12) are formed such that they each have a maximum width between 0.05 and 0.8 mm, preferably between 0.2 mm and 0.4 mm on the upper side (11) of the base unit (10) and/or each have a maximum depth and/or height between 0.1 mm and 1 mm, preferably between 0.2 mm and 0.4 mm.

5. Method according to claim 1, wherein the anchoring structures (12) are formed with an undercut (H) such that a respective anchoring structure (12) has at least one area which is formed wider than an area (12a) of the respective anchoring structure (12) on the upper side (11) of the base unit (10) and/or such that a plurality of anchoring structures (12) are formed to extend at an opposite angle.

6. Method according to claim 1, wherein the plurality of anchoring structures (12) are arranged in step b) exclusively in an area that corresponds to a projection surface (P) of the frame unit (13) to be applied in step c).

7. Method according to claim 1, wherein the step c) comprises that the second material (B) for applying the frame unit (13) is poured or injected by injection molding, onto and/or around the base unit (10).

8. Method according to claim 7, wherein the step c) comprises forming at least one or more functional elements (16) of the frame unit (10).

9. Method according to claim 8, wherein the functional element (16) comprises at least one of one or more screw-on elements (16c), one or more intermediate webs (16b), one or more (stiffening) ribs (16a) and one or more cable and/or conductor track guides.

10. Method according to claim 1, wherein the first material (A) essentially comprises aluminum and/or wherein the second material (B) essentially comprises a magnesium alloy, a refractory magnesium alloy, aluminum alloys and/or plastic.

11. Method according to claim 1, wherein the step c) comprises providing the frame unit (13) at least partially as a prefabricated part, in particular as a 3D printed prefabricated part or an injection molded prefabricated part, preferably placed on the base unit (10).

12. Method according to claim 11, wherein step c) comprises that the second material (B) of the prefabricated component is partially or locally liquefied or melted on a side that is in contact with or can be brought into contact with the base unit, by supplying heat.

13. Method according to claim 12, wherein the step c) comprises that a local melting of the frame unit (13) is performed by heating the base unit (10).

14. Method according to 11, wherein the step c) comprises that molten parts of the frame unit (13) are pressed with the base unit (10) so that the molten parts of the frame unit (13) positively fill or surround the anchoring structures (12) of the base unit (10).

15. Method according to claim 11, wherein the first material (A) essentially comprises aluminum and/or wherein the second material (B) essentially comprises plastic, fiber-reinforced plastic and/or carbon-reinforced plastic.

16. Method according to claim 1, wherein steps a) to d) are carried out in a press or a mold of an injection molding machine or, optionally, only step b) is carried out in advance.

17. Battery holding device (100), preferably monolithic battery holding device (100), for a vehicle, comprising as follows:
a base unit (10) made of a first material (A), which has an arrangement of a plurality of anchoring structures (12) on an upper side (11) and/or a further side;
a frame unit (13) made of a second material (B), which is arranged as a completely circumferential, frame on the upper side (11) of the base unit (10),
wherein frame unit (13) has a plurality of anchoring structures (14), each of which positively fills and/or surrounds a corresponding anchoring structure (12) of the plurality of anchoring structures (12) of the base unit (10).

18. Battery holding device (100) according to claim 17, wherein the base unit (10) is designed as an integral, extruded profile element, which has a plurality of fluid channels (15) for flushing through or for fluid cooling of the base unit (10).

19. Battery holding device (100) according to claim 17, wherein the frame unit (13) has a projection surface (P) which occupies at most 10%, at most 5% of the upper side (11) of the base unit (11).

20. Battery holding device (100) according to claim 17 to 19, wherein the first material (A) comprises aluminum and/or the second material (B) comprises one of a magnesium alloy, a refractory magnesium alloy, or an aluminum alloy, and/or the second material (B) comprises plastic, fiber-reinforced plastic and/or carbon-reinforced plastic.
